(19) United States
(12) Patent Application Publication
(10) Pub. No.: US 2024/0055704 A1
(43) Pub. Date: Feb. 15, 2024

(54) ELECTROCHEMICAL CELLS AND HEADERS HAVING SEALING FEATURES

(71) Applicant: EAGLEPICHER TECHNOLOGIES, LLC, Joplin, MO (US)

(72) Inventors: Dong ZHANG, Joplin, MO (US); Jason MUDGE, Joplin, MO (US); David DARCH, Joplin, MO (US); Mario DESTEPHEN, Joplin, MO (US); Ernest NDZEBET, Joplin, MO (US); Uma JANAKIRAMAN, Joplin, MO (US); Michael J. GORDON, Joplin, MO (US)

(21) Appl. No.: 18/268,015

(22) PCT Filed: Dec. 14, 2021
(86) PCT No.: PCT/US2021/063269

§ 371 Date: Jun. 16, 2023

Related U.S. Application Data
(60) Provisional application No. 63/126,146, filed on Dec. 16, 2020.

(51) Int. Cl. H01M 50/15; H01M 50/166; H01M 50/172; H01M 50/184; H01M 50/186; H01M 50/317; H01M 50/46

(52) U.S. Cl. CPC H01M 50/15; H01M 50/166; H01M 50/172; H01M 50/184; H01M 50/186; H01M 50/317; H01M 50/46

(57) ABSTRACT

A header for an electrochemical cell includes a planar plate configured to cover an internal volume of the electrochemical cell, and a side wall extending from an upper surface of the planar plate in a direction perpendicular to the upper surface. The header also includes a recess defined by the upper surface of the planar plate and the side wall, and a first step and a second step on a lower surface of the planar plate, the first step and the second step configured to seal the internal volume. An aspect of an electrochemical cell includes an anode, a cathode, a cell casing and the header.

### CROSS REFERENCE TO RELATED APPLICATIONS

This application claims priority to and the benefit of U.S. Provisional Application No. 63/126,146, filed Dec. 16, 2020, which is incorporated herein by reference in its entirety.

### BACKGROUND

Li/CFx electrochemical cells (Li/CFx batteries) are used as a power source in medical devices. For an implantable medical device, improved methods to reduce swelling during discharge would be desirable. Also, there remains a need for improved designs to ensure that fluids cannot leak into or out of the cell.

### BRIEF DESCRIPTION

An aspect of a header for an electrochemical cell includes a planar plate configured to cover an internal volume of the electrochemical cell, and a side wall extending from an upper surface of the planar plate in a direction perpendicular to the upper surface. The header also includes a recess defined by the upper surface of the planar plate and the side wall, and a first step and a second step on a lower surface of the planar plate, the first step and the second step configured to seal the internal volume. An aspect of an electrochemical cell includes an anode, a cathode, a cell casing and the header.

An aspect of an electrochemical cell includes a cathode assembly having a cathode, an anode assembly having an anode, and a header. The cell also includes an anode feedthrough pin extending through the header and protruding from a first lower surface of the header, the anode feedthrough pin electrically connected to the anode, and a cathode feedthrough pin extending through the header and protruding from a second lower surface of the header, the cathode feedthrough pin electrically connected to the cathode. At least one of the cathode assembly and the anode assembly includes a separator pouch, the separator pouch enclosing at least one of: the cathode and an interior portion of the cathode feedthrough pin, and the anode and an interior portion of the anode feedthrough pin.

An aspect of a header for an electrochemical cell includes a header body including a planar plate having an upper surface, the upper surface defining a shape that corresponds to a shape of an electrochemical cell casing. The header also includes a peripheral band configured to extend along a periphery of the upper surface, the peripheral band configured to be sealed to the upper surface and the casing. An aspect of an electrochemical cell includes an anode, a cathode, a cell casing and the header.

The above described and other features are exemplified by the following figures and detailed description.

### BRIEF DESCRIPTION OF THE DRAWINGS

FIGS. 1A and 1B depict an aspect of an electrochemical cell;

FIG. 2 is a cross-sectional view of an aspect of an electrochemical cell;

FIG. 3 depicts a header of an aspect of an electrochemical cell;

FIG. 4 is an exploded view of an aspect of an electrochemical cell;

FIG. 5 depicts an aspect of an anode current collector of the electrochemical cell of FIG. 4;

FIG. 6 depicts the anode current collector of FIG. 4 in a flat or unfolded state, and depicts aspects of a method of manufacturing or assembling components of the electrochemical cell of FIG. 4;

FIG. 7 depicts the anode current collector of FIG. 4 in a folded state, and depicts aspects of a method of manufacturing or assembling components of the electrochemical cell of FIG. 4;

FIG. 8 depicts an aspect of a cathode current collector;

FIGS. 9A and 9B depict an aspect of a component of an electrochemical cell including a cathode and an anode separator pouch, and depict aspects of a method of manufacturing or assembling components of an electrochemical cell;

FIG. 10 is a perspective view of an aspect of a header of an electrochemical cell having a stepped configuration;

FIG. 11 is a cross sectional view of the header of FIG. 10;

FIGS. 12A and 12B are perspective views of the header of FIG. 10;

FIG. 13 is a graph of cell voltage (volts, V) versus discharge capacity (percent, %) illustrating discharge capacity of an Li/CFx electrochemical cell of Example 1;

FIG. 14 is a graph of cell voltage (volts, V) versus discharge capacity (ampere hours, Ah) showing the results of discharge of an Li/CFx cell of Example 2; and

FIG. 15 is a graph of cell thickness change (percent, %) showing a degree of swelling of twenty-four Li/CFx electrochemical cells in the analysis of Example 3.

### DETAILED DESCRIPTION

Inventive aspects of the disclosure are explained in detail below with reference to the various drawing figures. Examples are described to illustrate the disclosed subject matter, not to limit its scope, which is defined by the claims. Those of ordinary skill in the art will recognize a number of equivalent variations of the various features provided in the description that follows.

The present disclosure relates to electrochemical cells, such as lithium/fluorinated carbon (Li/CFₓ) electrochemical cells for implantable medical devices. It is noted that the disclosed cells and components thereof are not so limited, as they may be used with a variety of components and configurations.

Systems, devices and methods for energy storage are provided herein. An aspect of an electrochemical cell includes a cathode assembly having a cathode, an anode assembly having an anode, a header, and anode and cathode feedthrough pins (or other connection devices or members). The electrochemical cell may include a header through which the anode and cathode feedthrough pins extend.

In an aspect, the electrochemical cell includes a header configured to cover an internal volume of the electrochemical cell and provide a fluid tight seal to prevent leakage of a fluid, such as an electrolyte, from the interior of the cell, and to prevent any incursion of fluids into the internal volume of the cell. The electrochemical cell in this aspect may be used for applications in which the cell may be exposed to fluids, such as bodily fluids encountered when the cell is implanted into a patient. An aspect of the header includes a planar plate and a side wall extending from an upper surface of the planar plate in a direction perpendicular to the upper surface, or in a direction that defines a selected angle relative to the upper surface. A recess in the header is defined by the upper surface of the planar plate and the side wall. In an aspect, the header includes or is attached to a peripheral band configured to facilitate the provision of a fluid tight seal.

In an aspect, the electrochemical cell includes a stepped header, in which a lower surface of the header (e.g., a lower surface of a header plate or body) includes at least one stepped structure (or simply “step”). For example, the header includes a first step and a second step on a lower surface of the planar plate, the first step and the second step configured to seal the internal volume.

An aspect of an electrochemical call includes at least one interior pouch, referred to as a separator pouch, which encases an anode or cathode to isolate the anode or cathode from other internal components of the cell. The electrochemical cell may include a single pouch or multiple pouches. For example, the cell may include a separator pouch encasing the cathode, or respective separator pouches encasing both the anode and the cathode. The separator pouches may be made from a material that can isolate components while allowing for ion migration, such as a microporous polyethylene or polypropylene material.

Aspects of electrochemical cells and cell components described herein present a number of advantages and address a number of problems. For example, recessed headers as described herein provide for superior sealing capabilities, allowing electrochemical cells to be incorporated in devices that may be exposed to various fluids. In addition, stepped headers as describes herein provide for effective sealing while accommodating various components, including feedthrough pins and filling assemblies.

Conventional headers of electrochemical cells are typically constructed with a flat top. However, such headers are deficient. Known headers can fail to provide a sufficient interior volume size to minimize external size of the cell in conjunction with providing structure needed to accommodate various components in the header assembly and the overall cell assembly. Known headers are also deficient in that they involve or require relatively complex sealing methodologies to reliably isolate the electrolyte and other subcomponents from human tissues and body fluids. The headers described herein address such deficiencies.

For example, aspects of an electrochemical cell described herein use a recessed header instead of a flat cell top. The recessed header allows reliable isolation of electrolyte and other cell components from human tissues and body fluids. In addition, the recessed header provides a good periphery for joining other components to the electrochemical cell, for example, in an implantable cardiac monitor device or other device that may be exposed to fluids.

Aspects described herein allow electrochemical cells to attain electrolyte volume goals and void volume goals. Accordingly, the electrochemical cells described herein can provide a high energy-density.

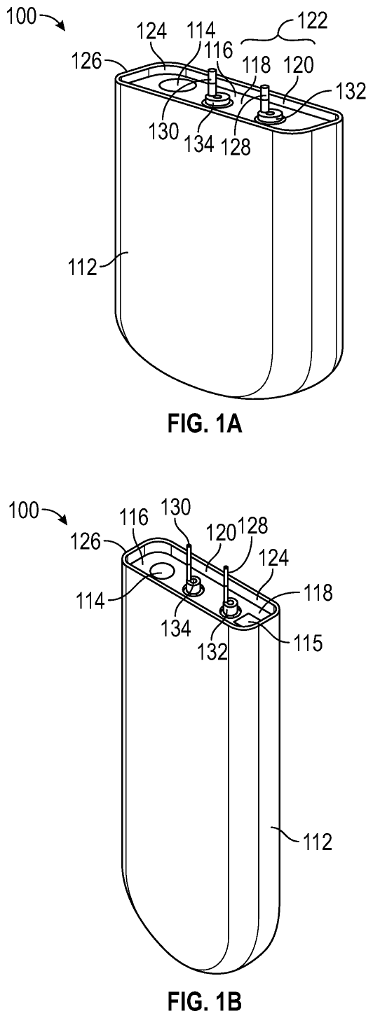

FIGS. 1A and 1B illustrate aspects of the electrochemical cell 100. The electrochemical cell 100 may include one or more voltage generating components (not shown in FIG. 1), including an anode, a cathode, an electrolyte, and one or more separators between the anode and the cathode that are disposed within a cavity of a casing 112. In an aspect, the electrochemical cell 100 is a lithium/fluorinated carbon (Li/CFₓ) cell, in which the anode is made from or includes lithium, and the cathode is made from or includes a fluorinated carbon. However, the electrochemical cell 100 is not so limited, and may include various anode and cathode materials.

The electrochemical cell 100 can be used in various contexts. For example, the cell 100 can be used as part of an implantable medical device such as an implantable cardiac monitor (ICM) device. The cell 100 is not so limited and can be used with various medical and non-medical devices.

The cavity of the casing 112 is covered by a header 122 that is configured to isolate internal components in the cavity and provide a fluid-tight seal. The header 122 includes a planar (flat) plate 118 and a side wall 120, which is a portion of the casing 112. The header 122 also includes a recess 116 defined by the planar plate 118 and the side wall 120. In an aspect, the side wall 120 extends perpendicular to the surface of the planar plate 118. In an aspect, the side wall 120 defines an angle of about 90 degrees relative to the surface of the planar plate 118. The top of the side wall 120 extends to a predetermined height (distance from the plate 118) and extends along a periphery of the planar plate 118.

The top of the side wall 120 defines a casing edge 126 that extends along an external periphery of the side wall 120, and a header edge 124 that extends along an internal periphery of the side wall 120. The recess 116 is designed to allow isolation of the electrolyte and other cell components from external fluids (e.g., human tissue or body fluid). The recess 116 also provides a suitable periphery for joining other components. For example, the recess 116 may provide a suitable surface for coupling various parts, such as leads 128 and 130, with a medical device including the electrochemical cell 100.

The height of the side wall 120 substantially defines the depth or height of the header recess 116, while the width of the planar plate 118 substantially defines the width of the recess 116. According to an example, the height of the side wall 120 is 0.5 millimeters (mm) to 1.5 mm. In an aspect, the height of the side wall 120 is 0.5 mm to 1 mm. In an example, the height of the side wall 120 is 0.5 mm to 0.75 mm. In another example, the height of the side wall 120 is 0.6 mm to 0.72 mm. According to a further example, the height of the side wall 120 is 0.69 millimeters (mm). Examples of lengths of the plate 118 are 9.0 mm to 10.0 mm, or 9.5 mm. Examples of widths of the plate 118 are 2.6 mm to 3.9 mm, or 2.6 mm.

The header 122 includes or may be connected to various connection components that allow for electrically connecting a device to the electrochemical cell 100. In an aspect, the cell 100 includes an anode connection device 132 and a cathode connection device 134, both of which extend through the planar plate 118. The connection devices may take the form of feedthrough pins or other conductive members. The header 122 may also include one or more openings, such as an opening for use in filling the cavity. For example, the header 122 includes a fill assembly including a fill port cover 114. As shown in FIG. 1A, the cell 100 may include an identifier or label 115, such as a Quick Response (QR) code

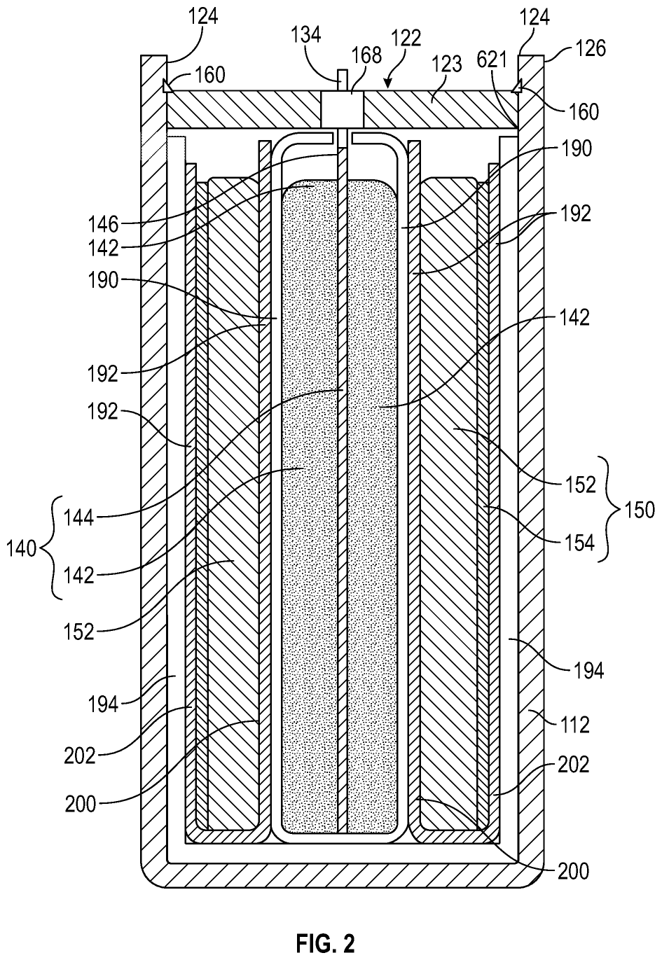

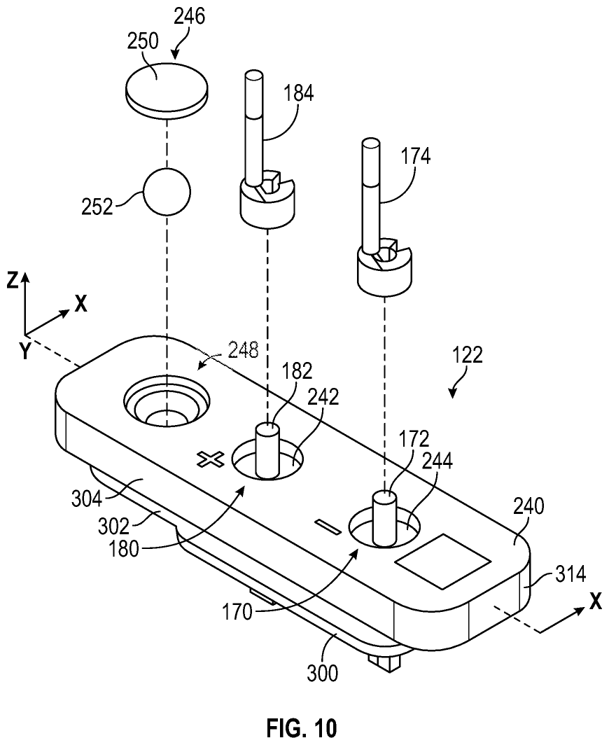

FIG. 2 is a cross-sectional view of an aspect of the electrochemical cell 100. It is noted that the cell 100 is not limited to the specific components, configuration and materials discussed herein. The electrochemical cell 100 includes the cell casing (or battery case) 112 that houses a cathode assembly 140 having a cathode 142, a cathode current collector 144, a cathode positive connection component such as a current collector tab 146. The current collector tab 146 is electrically connected to an interior portion (inside of the casing 112) of the cathode connection device 134, which in turn extends through a body 123 of the header 122. The body 123 in this aspect is a planar body defined by the plate 118, but is not so limited, as the body 123 can have any desired shape and size. For example, the header body 123 can have a stepped shape or include multiple components, as described further below (see FIGS. 10-12).

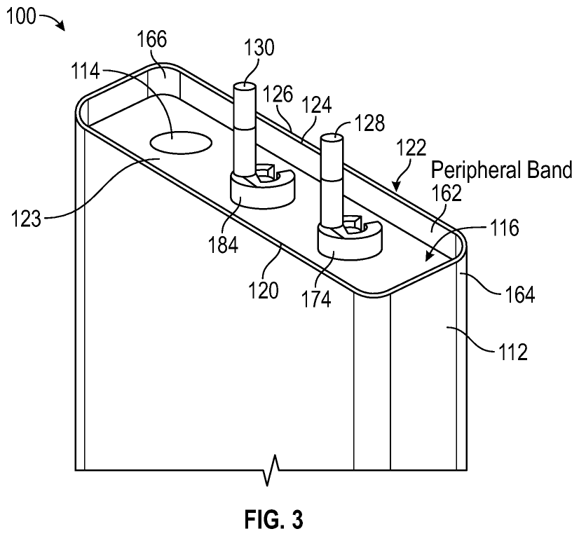

The cathode 142 may be formed by pressing a cathode composition in the form of individual pellets onto the cathode current collector 144. The electrochemical cell 100 also includes an anode assembly 150 having an anode 152 and an anode current collector 154. The anode 152 may be in the form of a flat plate, referred to as a coupon, such as a lithium coupon. In an aspect, the anode assembly 150 includes two anodes 152 disposed at opposing sides of the cathode, as illustrated further in FIG. 3. The anode assembly 150 is thus disposed such that the anodes 152 sandwich the cathode assembly 140.

FIG. 2 also illustrates aspects of a sealing engagement or mechanism incorporated with the header 122. For example, the cell casing 112 is closed (sealed) with the header body 123 by welding along a circumference of the header body 123 to the cell casing 112 by welding ring 160. Examples of suitable welding processes include laser welding, ultrasonic welding, spot welding and others. The cathode connection device feedthrough pin 134, in an aspect, is sealed to the header body 123 a glass to metal seal 168 or other suitable sealing mechanism. The anode connection device 132, although not shown in FIG. 2, may be sealed by a similar mechanism to prevent leakage of volatile components, e.g., electrolyte solvent, from the electrochemical cell 100.

FIG. 3 depicts an aspect of the electrochemical cell 100 and the header 122, which includes features for facilitating the formation of a fluid tight seal. In this aspect, a peripheral band 162 is included to facilitate forming a seal between the casing 112 and the header 122. The peripheral band 162 encircles or surrounds the header body 123, and provides a surface to allow a weld or other sealing mechanism (e.g., an adhesive such as an epoxy) to be applied to the casing 112 and the header body 123 to provide a fluid tight seal. The peripheral band 162 also facilitates providing a fluid tight seal when a medical device or other device is connected to the electrochemical cell 100. For example, when a device is connected to the feedthrough pins, another seal e.g., a second weld, can be applied to an engagement surface of the device, so that a double seal is provided. The double seal ensures that bodily fluids or other external fluids are isolated from the connections.

In FIG. 3, the peripheral band 162 is defined by or integral with an upper portion 164 of the casing. For example, the peripheral band 162 has an inner surface 166 corresponding to a surface of the upper portion 164. In other examples, the peripheral band 162 is a separate component, such as a ring, that is attached to inner surfaces of the upper portion 164. The peripheral band 162 can be rectangular in shape, circular in shape, annular in shape, or in some other shape as dependent upon the interior surface shape of the casing 112. The inner surface 166 provides a surface on which a connected device can be welded or otherwise sealed.

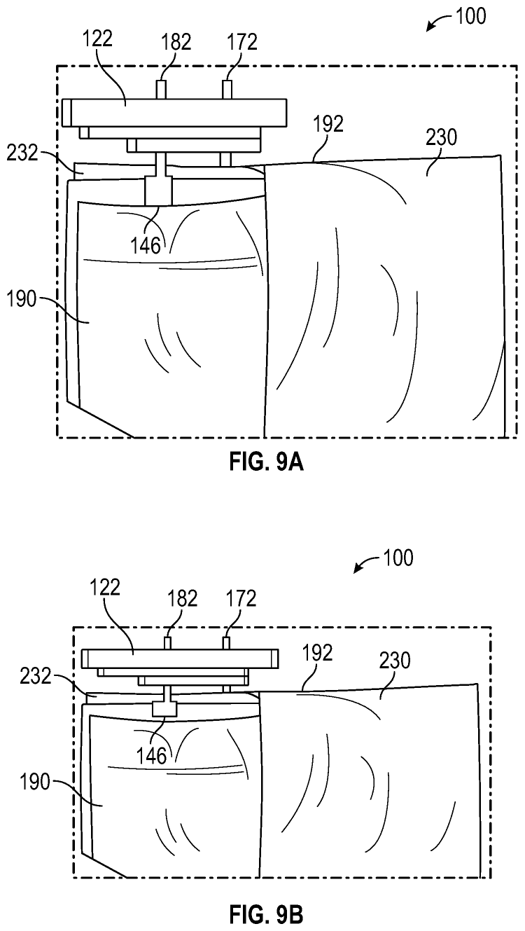

The header 122 may be configured to support components of a cathode connection assembly 180, which includes a cathode feedthrough pin 182 (shown in FIGS. 9-11) that extends through a hole or passage in the header body 123 and provides an electrical connection from the cathode 142 to an exterior of the cell 100. The cathode connection assembly 180 may include additional component such as a pin extender 184 that connects to or forms the lead 128.

The header 122 is also configured to support components of an anode connection assembly 170, which includes an anode feedthrough pin 172 (shown in FIGS. 9-11) that extends through a hole or passage in the header body 123 and provides an electrical connection from the anode 152 to an exterior of the cell 100. The anode connection assembly 170 may also include component such as a pin extender 174 that connects to or forms the lead 130. Both pin extender 184 and 174 may be plated and/or otherwise enhanced in conductivity so as to provide good electrical connection to further electrical respective connections.

The electrochemical cell 100 may include one or more separation components, or separators, to keep the anode(s) and cathode separated and prevent electrical short circuits. In an aspect, the cathode assembly 140 and/or the anode assembly 150 includes a separator pouch that may be flexible or rigid and forms a pocket in which components of the anode assembly 150 or cathode assembly 140 can be enclosed. The separator pouch includes an opening to allow components to be disposed therein and to allow electrical connections to the header 122. In the following description, the electrochemical cell 100 includes a separator pouch for each of the cathode assembly 140 and the anode assembly 150. However, the cell 100 is not so limited, as it can have one separator pouch (e.g., for the cathode assembly 140), no separator pouches, or other types of separation components.

Referring again to FIG. 2, in an aspect, the electrochemical cell 100 includes a cathode separator pouch 190, which encloses the cathode 142 (e.g., a cathode composition formed from compressed pellets or otherwise), the cathode current collector 144, and the cathode current collector tab 146. A portion of the cathode feedthrough pin 182 may extend from a lower surface of the header body 123 and be covered by the cathode separator pouch 190. An anode separator pouch 192 encloses each anode 152 and the anode current collector 154. The anode assembly and the cathode assembly may be enclosed in an insulator pouch 194, which is covered by the cell casing 112.

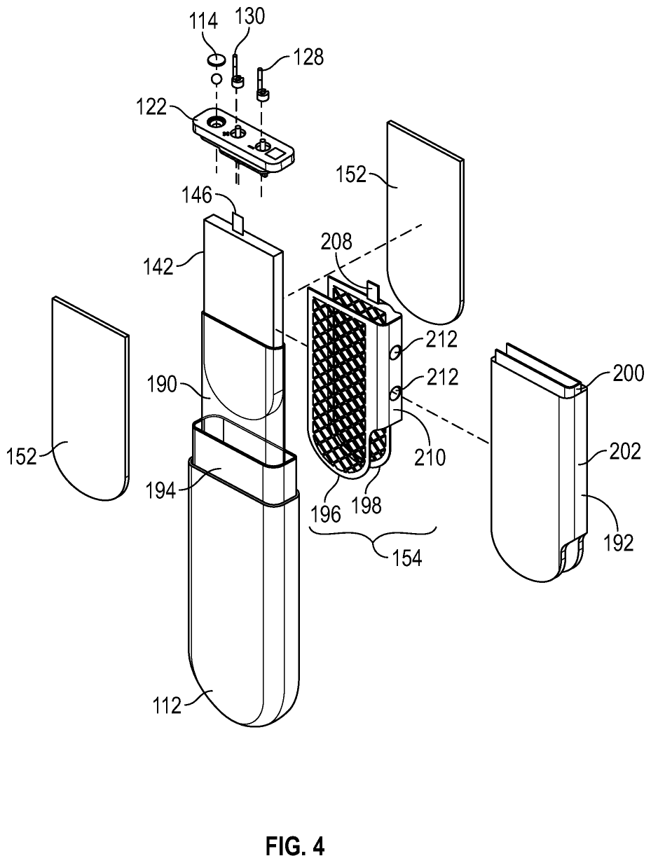

FIG. 4 is an exploded view of an aspect of the electrochemical cell 100 that illustrates the relative configurations of internal cell components. As shown, the cathode 142 and the cathode current collector 144 are inserted into and enclosed by the cathode separator pouch 190. The current collector tab 146 is at least partially enclosed by the cathode separator pouch 190, and is electrically connected to the cathode feedthrough pin 182. In an aspect, the cathode 142 includes a cathode composition that is pressed, deposited on or otherwise disposed on opposing surfaces of the cathode current collector 144. The cathode composition may be in the form of, for example, pellets or other granular material. The tab portion 146 of the cathode current collector 144 may be enclosed within the cathode separator pouch 190, or optionally, may extend outside of the cathode separator pouch 190.

The anode assembly includes anodes 152, which are configured as, for example, lithium coupons, and an anode current collector 154. The anode current collector 154 may be constructed of material such as stainless steel or copper, for example. In addition, the anode current collector 154 has a folded shape that includes perforated side plates 196 and 198. The anode current collector 154, as also shown in FIG. 4, can be perforated in accordance with one or more aspects. However, such construct including perforations is for purposes of illustration and an electrochemical cell of the disclosure can include other constructs and other types of anode current collectors.

An aspect of the anode separator pouch 192 includes an inner lining 200 and an outer lining 202. The separator pouch 192, in this aspect, is generally shaped to conform to the shape of the anode assembly 150 and the cathode assembly 140. For example, as shown in FIG. 4, the anode separator pouch 192 has a generally rectangular shape having a rounded bottom.

The inner lining 100 height can be greater than the outer lining 102 height, to provide good isolation between the cathode assembly 140 and the anode assembly 150. As part of an assembly or manufacturing method, the anode current collector 154 and the anodes 152 can be slid into the anode separator pouch 192 from above the anode separator pouch 192, i.e. slid into the top of the anode separator pouch 192. In particular, one side of the anode assembly 150, including an anode 152 and the plate 196, can be slid into one side of the anode separator pouch 192 between the outer lining 202 and the inner lining 200. Likewise, another side of the anode assembly 150, including an anode 152 and the plate 198, can be slid into another side of the anode separator pouch 192 between the outer lining 202 and the inner lining 200. As a result, the arrangement illustrated in FIG. 4 can be provided.

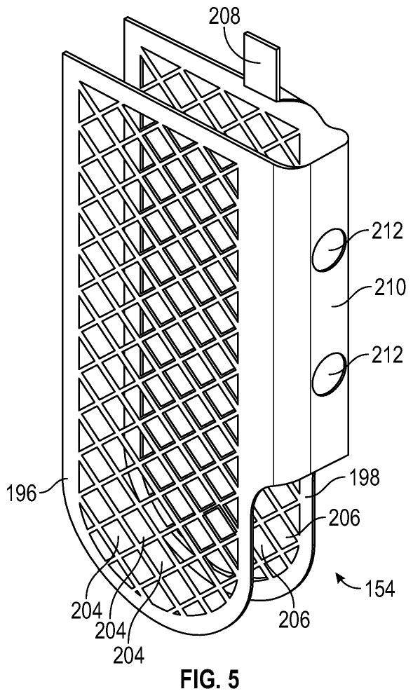

FIG. 5 is a perspective view of an aspect of the anode current collector 154. In this aspect, the anode current collector 154 is a perforated current collector that includes the perforated plate 196 having a plurality of perforations 204, and the perforated plate 198 having a plurality of perforations 206. The perforations may have rectangular or diamond shapes as shown in FIG. 5, or may having any other suitable shape and size. In addition, the perforations 204 may be the same as or different from the perforations 206. In an aspect, the perforations 204 and 206 may have diamond shapes, circular shapes, rectangular shapes, square shape and/or other shapes. The ratio of perforated area to the total area of the collector (excluding the central folding and tabbing area) may be about 0.6, for example. The thickness of the current collector 154 may be about 0.050 mm, for example.

The anode current collector 154, in an aspect, includes a negative connection tab 208 that can be electrically connected to a feedthrough pin or other connection device. The anode current collector 154 may be in a folded or book-like configuration as shown in FIG. 5, in which the plates 198 and 196 are parallel to one another. It is noted that the anode current collector 154 is not so limited and can have any size and shape sufficient to allow the current collector to transmit current.

An alignment feature may be provided in the anode current collector 154 to facilitate proper anode to current collector alignment and proper anode current collector folding. For example, the anode current collector 154 includes a fold portion or central alignment portion 210. Holes or apertures 212 in the alignment portion 210 allow the anode current collector 154 to sit in a fixed, stationary position, so that lithium coupons (or other anodes) may be pressed properly onto the anode current collector 154. The apertures 212 also allow for easy folding of the anode current collector 154 to provide the proper geometry for sandwiching the cathode 142 to fit into the cell casing 112.

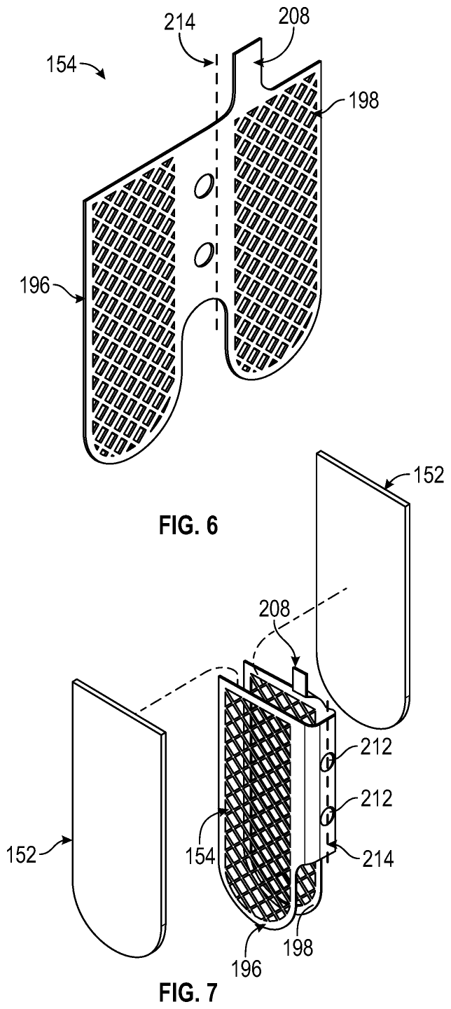

FIGS. 6 and 7 illustrate aspects of assembly or manufacture of the anode current collector 154. Referring to FIG. 6, the anode current collector is initially manufactured by casting, machining or otherwise forming a conductive material as a flat body (in a flat or folded state). Referring to FIG. 7, the flat body is folded along a central axis 214 to form a book like structure, in which the side plates 196 and 198 are parallel, and the alignment portion 210 defines an alignment surface 216 that is orthogonal to the side plates 196 and 198. The cathodes 152 are aligned with and disposed on inner surfaces of the side plates 196 and 198, either before or after folding. In an aspect, the anodes are disposed (e.g., pressed) directly on the inner surfaces of the perforated side plates 196 and 198. The electrochemical cell 100 may then be further assembled by sandwiching the cathode 142 (and the separator pouch 190, if included) in between the anodes 152 and the side plates 196 and 198. If the electrochemical cell includes the anode separator pouch 192, the folded anode current collector 154 and the anodes 152 are slid between or otherwise disposed between the inner and outer linings 200 and 202.

The cathode current collector 144 (shown in FIG. 2) may have a perforated structure. An advantage of using a cathode current collector including a perforated structure is improved pellet adhesion which occurs around the edges of the perforations.

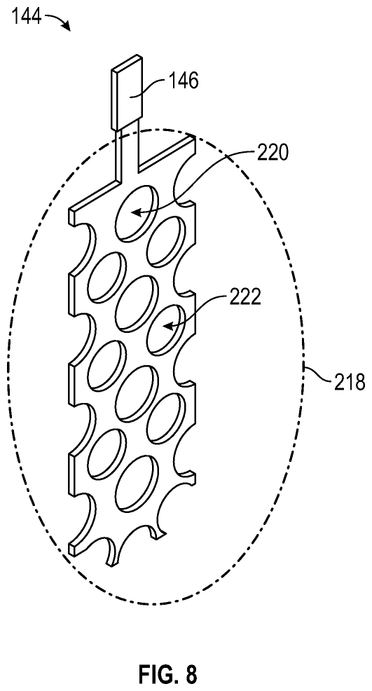

FIG. 8 depicts a portion of an aspect of the cathode current collector 144, which includes a perforated plate having circular perforations 218, and a connection device such as the current collector tab 146. The perforations 218 may have the same or different size and shape. The perforations 218 may include relatively large perforations 220 and relatively small perforations 222, i.e., the perforations 220 are larger than the perforations 222. In a given perforated plate, the average size of the large perforations 220 and the average size of the small perforations 222 are distinct from one another and do not overlap. An example of suitable dimensions includes an average diameter of the large perforations 220 of about 2.4 millimeter (mm), an average diameter of the small perforations 222 of about 1.9 mm, and a ratio of the area defined by the perforations to a total area of the cathode current collector 144 (excluding the tab 146) is about 0.6. In another example, an average diameter of the large perforations 220 is about 1 mm to about 10 mm. In another example, an average diameter for the large perforations 220 is about 1.5 mm to about 5 mm. In yet another example, a diameter for the large perforations 220 is about 2 mm to about 3 mm. In an example, an average diameter for the small perforations 222 may be in a range of about 0.5 mm to about 5 mm. In another example, an average diameter for the small perforations 222 is in a range of about 0.75 mm to about 3 mm. In yet another example, an average diameter for the small perforations 222 is in a range of about 1 mm to about 2.2 mm. The perforated plate may be made of stainless steel or other suitable material.

As discussed above, the electrochemical cell 100 may include one or more separator pouches, such as the cathode separator pouch 190 and/or the anode separator pouch 192. FIGS. 9A and 9B illustrate internal components of an aspect of the electrochemical cell 100 in a partially assembled state. The cathode 142 and cathode current collector 144 are entirely surrounded or wrapped by the cathode separator pouch 190, and the tab 146 may extend from the pouch 190 to connected to the feedthrough pin 182. In this aspect, the anode separator pouch 192 includes a first portion 230 in which the one of the anodes 152 and one of the current collector plates 196, 198 is disposed. Another of the anodes 152 and another of the plates 196,198 is disposed in a second portion 232 of the pouch 192. In order to prepare the components for insertion into the casing 112 or other housing, the anode separator pouch 192 and the current collector 144 are folded into a folded configuration so that the cathode 142 and the cathode separator pouch 190 are sandwiched between the plates and the anodes.

As shown in FIGS. 9A and 9B, each of the cathode separator pouch 190 and the anode separator pouch 192 may extend to at least partially cover the cathode feedthrough pin 182 and the anode feedthrough pin 172, respectively. Extending the separator pouches to cover the feedthrough pins helps mitigate internal short circuits, which may be caused due to cathode expansion during discharge.

As noted above, the electrochemical cell 100 may include a stepped header. The stepped header can include multiple step portions, referred to as steps. A “step” as described herein refers to a portion of a header or header body having a defined thickness. The stepped design of the disclosed header can allow for enhanced or maximized internal cell volume. In the following, the stepped header defines three step portions, but is not so limited. For example, the stepped header may have fewer than the three steps, and may have any desired number of steps.

A first “step” of the cell can be designed and constructed to accommodate sealing features, such as glass-to-metal seal assemblies or configurations. A second “step” of the cell can be designed and constructed around ball seal requirements. The electrochemical cell 100 can, as a result, provide increased internal volume, the utilization of which allows the cell 100 to attain electrolyte volume goals and void volume goals. Accordingly, the electrochemical cell 100 can be a high-energy-density electrochemical cell.

FIGS. 10-12 depict an aspect of the header 122 having a stepped configuration. In this aspect, the header 122 includes a header body 240 that includes a first step portion 300, a second step portion 302, and a third step portion 304. The step portions 300, 302 and 304 are shaped and dimensioned so as to provide for a filling assembly and to provide desired stability and support to the feed through pins 172 and 182, and so as to accommodate or support other components as described herein.

The header 122 in this aspect includes the stepped header body 240, a cathode feedthrough passage 242 for accommodating a cathode feedthrough pin 182 or other connection device, and an anode feedthrough passage 244 for accommodating an anode feedthrough pin 172 or other connection device. As shown in FIG. 10, the passages may be configured or sized to allow pin extenders 174 and 184 to be included.

The header 122 may also include a fill assembly 246 for filling interior cavities of the cell with an electrolyte. The fill assembly 246 includes a fill aperture 248 and a cover 250. The fill aperture 248 may be provided to add or remove electrolyte from the cell 100. The fill aperture 248 may be provided with a valve to prevent fluid flow there through. In this example, the fill assembly 246 includes a ball seal or ball 252. The fill aperture 248 is dimensioned about a centerline so as receive the ball 252 in a ball recess 254.

The electrolyte comprises, for example, a salt dissolved in a solvent. Suitable salts include lithium salts of BF₄⁻, PF₆⁻, AsF₆⁻, SbF₆⁻, AlCl₄⁻, HSO₄⁻, ClO₄⁻, CH₃SO₃⁻, CF₃CO₂⁻, (CF₃SO₂)₂N⁻, Cl⁻, Br⁻, I⁻, SO₄⁻, (C₂F₅SO₂)₂N⁻, (C₂F₅SO₂)(CF₃SO₂)N⁻, NO₃⁻, Al₂Cl₇⁻, CF₃COO⁻, CH₃COO⁻, CF₃SO₃⁻, (CF₃SO₂)₃C⁻, (CF₃CF₂SO₂)₂N⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, (O(CF₃)₂C₂(CF₃)₂O)₂PO⁻, or (CF₃SO₂)₂N⁻.

The solvent may be at least one selected from a carbonate-based solvent, an ester-based solvent, an ether-based solvent, a ketone-based solvent, an amine-based solvent, and a phosphine-based solvent. Examples of suitable carbonate solvents include at least one selected from ethylene carbonate, propylene carbonate, dimethyl carbonate, diethyl carbonate, and ethyl methyl carbonate. Non-limiting examples of suitable ester-based solvents include at least one selected from n-methyl acetate, n-ethyl acetate, n-propyl acetate, dimethyl acetate, methyl propionate, ethyl propionate, γ-butyrolactone, decanolide, valerolactone, mevalonolactone and caprolactone. Non-limiting examples of suitable ether-based solvents include at least one selected from dibutyl ether, tetraglyme, diglyme, dimethoxyethane, 2-methyltetrahydrofuran and tetrahydrofuran. Non-limiting examples of suitable ketone-based solvents include cyclohexanone and polymethyl vinyl ketone. Examples of the amine-based solvent include at least one selected from triethyl amine and triphenylamine. An example of the phosphine-based solvent includes triethyl phosphine.

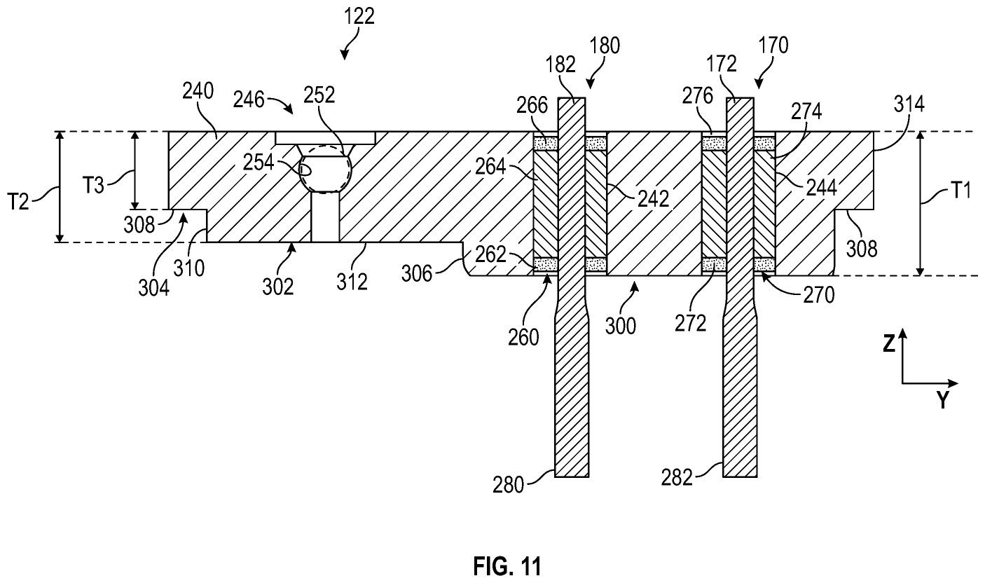

As shown in FIG. 11, the cathode feedthrough pin 182 may be supported by a substrate assembly 260 that includes a lower substrate socket 262, a substrate sleeve 264, and an upper substrate socket 266. The substrate assembly 260 can provide a seal around and/or provide support to the feedthrough pin 182 in the cathode feedthrough pin passage 242. The substrate assembly 260 provides a fluid tight seal in the passage 242 to prevent fluid from entering the passage 242. The lower substrate socket 262 and the upper substrate socket 266 can be annular in shape, i.e. toroidal or ellipsoidal, so as to encircle the feedthrough pin 182. The lower substrate socket 262, the upper substrate socket 266 and the sleeve 264 may be made from glass, resin or other suitable electrically insulating material.

The header 122 may also include a substrate assembly 270 for providing a seal around and/or for providing support to the anode feedthrough pin 172 in the anode feedthrough pin passage 244. The substrate assembly 270 includes a lower substrate socket 272, a substrate sleeve 274, and an upper substrate socket 276. The lower substrate socket 272 and the upper substrate socket 276 can be annular in shape to encircle the feedthrough pin 172. The lower substrate socket 272, the upper substrate socket 276 and the sleeve 274 may also be made from glass, resin or other suitable electrically insulating material.

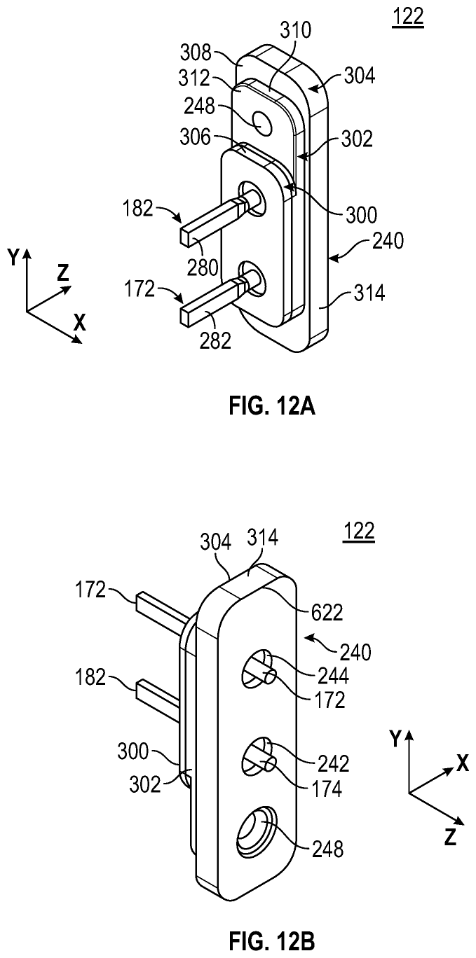

The anode and cathode feedthrough pins 172 and 182 include lower portions that extend through the header 122 and into the interior of the cell 100 in order to electrically connect to the anode and cathode in the cell 100. The lower portions have respective lengths and dimensions so as to connect to the anode and cathode. For example, as shown in FIGS. 11 and 12, the cathode feedthrough pin 182 includes a lower flattened portion 280 on one or more sides so as to effectively engage with a cathode tab or other connection (e.g., the cathode current collector tab 146) and provide an electrical connection. The anode feedthrough pin 172 may also include a lower flattened portion 282 on one or more sides so as to effectively engage with an anode tab or other connection (e.g., the anode current collector tab 208).

The first step portion 300 has a thickness T1 in an axial direction (defined by axis Z), which may correspond to a longitudinal axis of the electrochemical call 100 and/or may be parallel to the longitudinal axes of the feedthrough pins 172 and 182. The thickness T1 is selected so that the glass (or other insulting material) has a sufficient volume to provide an effective hermetic and fluid seal within the cathode passage 242 and the anode passage 244. Thus, the first step portion 300 can effectively accommodate the cathode connection assembly 170 and sealing components, and affectively accommodate the anode connection assembly 180 and sealing components.

The second step portion 302 has a thickness T2 that is selected so that the fill aperture 248 can be made of sufficient length to accommodate the ball or ball seal 252 and the ball recess 254, and so that the contact area of the ball or ball seal 252 to the header body 240 is adequate to hold the ball and place. The ball 252 can be sufficiently small so that the thickness T2 of the second step portion 302 can be smaller than the thickness T1 of the first step portion 300. As a result, more cell internal volume can be yielded.

The header body 240 includes a riser surface 306 that provides a transition between the first step portion 300 and the second step portion 302. As shown, the riser surface 306 defines a curved or rounded shape to provide a smooth transition, however the riser surface 306 may define any suitable shape.

The stepped arrangement of the header body 240 provides needed depth of material in order to accommodate particular components in particular parts or portions of the header body 240. In addition, the arrangement provides the ability to not exceed the depth of material that is needed. Accordingly, since the depth of material that is needed to accommodate the fill assembly 246 is less than the depth of material that is needed to accommodate the connection assemblies, the second thickness T2 can be less than the first thickness T1.

The header body 240 may also include the third step portion 304, which is constructed to have a third thickness T3. The third step portion 304 defines a step surface 308. The third thickness T3 is selected so that the header body 240 can be installed on and sealed with the casing 112. For example, the third step portion has a shape in a plane orthogonal to the Z-axis (in a plane defined by an X-axis and a Y-axis as shown in FIGS. 11, 12A and 12B) that is selected to conform to the casing 112. Thus, the header body 240 can be installed on the casing and effectively sealed to the casing 112. The third thickness T3 may be smaller than the first and second thicknesses T1 and T2.

The header body 240 can also include a second riser surface 310 extending between the step surface 308 and a surface 312 of the second step portion 302. As shown in FIGS. 12A and 12B, for example, the third step surface 308 can extend around an outer periphery or perimeter of the header body 240. The third step surface 308 and the second riser surface 310 can engage with the casing wall and/or interior components in an interior volume of the electrochemical cell 100. As a result, the header body 240 can be secured to the housing wall.

As shown in FIGS. 12A and 12B, the step surface 308 terminates at a periphery of the third step portion 304, and surrounds (in the X-Y plane) the second step portion 302. The periphery defines a shape that corresponds to a shape of the casing so that the header body 240 can be sealed to the casing 112. For example, the third step portion 304 includes an outer edge face 314 that can be seated with or mated with an inner surface of the casing 112. The outer edge face 314 can be secured to the casing 112 via a welding ring, peripheral band or other suitable sealing mechanism.

The step portions also have varying shapes and dimensions in the X-Y plane (orthogonal to the direction of the thicknesses T1, T2 and T3). For example, as shown in FIGS. 12A and 12B, the third step portion 304 has a width (X-axis) and a length (Y-axis) substantially the same (with a suitable tolerance) as the width and length of the casing 112. The second step portion 302 has a length and width that are less than the length and width of the third step portion 304. The width of the first step portion 300 and the second step portion 302 are at least substantially equal, and the length of the second step portion 302 is greater than the length of the first step portion 300.

The following is a description of examples of dimensions of the header body 240 and step portions. The examples are provided for illustration purposes and are not intended to be limiting. For example, the thickness of the first step portion 300, i.e., the first step, may be in a range of about 1.1 mm (millimeter) to about 1.9 mm. In another example, the thickness of the first step portion 300 may be in a range of about 1.2 mm to about 1.8 mm. In yet another example, the thickness of the first step portion 300 may be in a range of about 1.3 mm to about 1.7 mm, e.g., about 1.5 mm.

The thickness of the second step portion 302, i.e. the second step, may be in a range of about 0.7 mm to about 1.5 mm. In another example, the thickness of the second step portion 302 may be in a range of about 0.8 mm to about 1.4 mm. In yet another example, the thickness of the second step portion 302 may be in a range of about 0.9 mm to about 1.3 mm, e.g., about 1.1 mm.

It is appreciated that the various components described herein may be made from any of a variety of materials including, for example, metal, aluminum, stainless steel, nickel, titanium, plastic, plastic resin, nylon, composite material, glass, and/or ceramic, for example, or any other material as may be desired. The material of the header body, for example, can be constructed of titanium or stainless steel. The material of the casing, for example, can be constructed of titanium or stainless steel.

This disclosure is further illustrated by the following examples, which are non-limiting.

### EXAMPLES

### Example 1: Swelling Characteristics

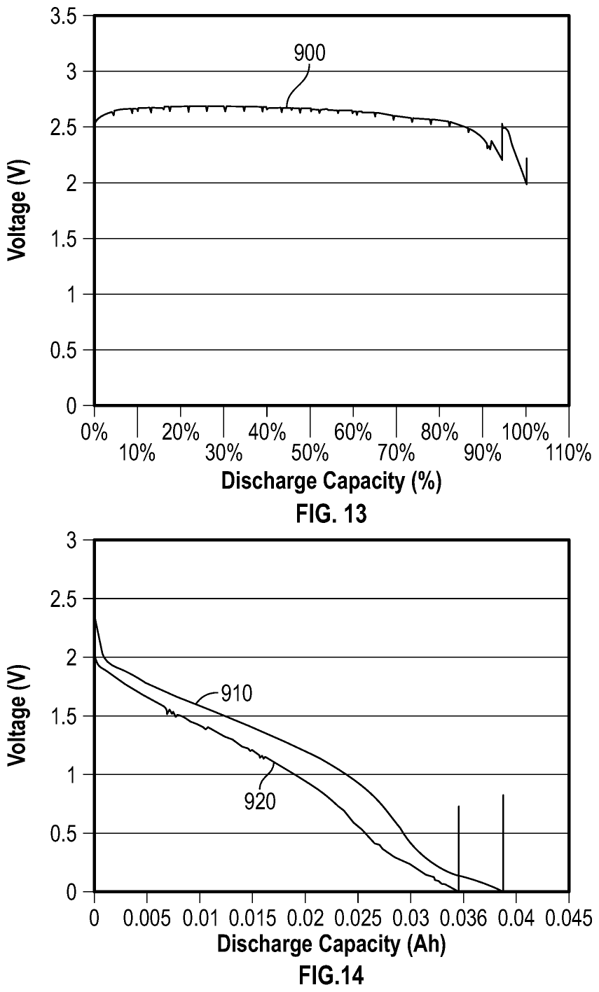

One Li/CFx cell was constructed according to aspects described herein, including a recessed header, a cathode pouch, and a stepped header. The electrochemical cell constructed in Example 1 was discharged from 2.5 V to 2.0 V in a 5-day accelerated protocol, in which the cell was discharged at 37° C. and at a 1.6 mA rate with a 2 mA/180 seconds pulse every 5 hours. The cell voltage during the discharge is shown as a curve 900 in FIG. 13. The swelling observed for the cell was 1.0 percent. As mentioned herein, “swelling” is defined and was determined as the difference in the cell thickness in a discharged state and the cell thickness in an undischarged state divided by the thickness of the cell in the undischarged state. Thickness measurements were made at the center of the two largest surfaces of the cell. The discharge protocol was also performed for another cell having at least substantially the same construction, and the change in thickness was determined as an average of two different cells.

### Example 2: Swelling Characteristics of Two Cells

Two Li/CFx cells were constructed as described for Example 1, i.e., the two cells had at least substantially the same construction as the cell of Example 1. according to aspects of the present inventions as described with reference to Example 1 above. The two cells were discharged under a 5-day accelerated protocol, which included discharging the cells at 37° C. and at a 0.25 mA rate, and changes in thickness were measured. FIG. 14 illustrates deep discharge of the two Li/CFx electrochemical cells. The cells constructed in Example 2 were discharged from 2.5 V to 2.0 V in a 5-day accelerated protocol and the discharge capacity was plotted as a curve 910 for the first cell, and curve 920 for the second cell. After discharge of the two cells to 0.01V, the cell swelling was calculated as about 0.5 percent for the first cell, and about 1 percent for the second cell, when calculated as described hereinabove in Example 2 in comparison to the dimensions of undischarged cells.

### Example 3: Swelling Characteristics of Twenty-Four Cells

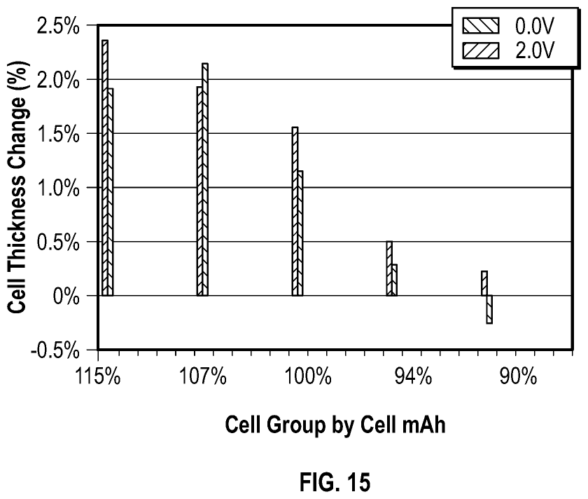

Twenty-four Li/CFx cells were constructed as described with reference to Example 1 above, i.e., the twenty-four cells had at least substantially the same construction as the cell of Example 1. These twenty-four cells were first discharged to 2.0 Volts by an accelerated protocol and the cell thickness was measured at this stage. The accelerated protocol included discharge at 37° C. and at a 0.16 mA rate with a 2 mA/180 seconds pulse every 5 hours. The cells were then discharged to 0.0 Volts at 0.25 mA, and the cell thickness was measured again. FIG. 15 illustrates a degree of swelling of the twenty-four Li/CFx electrochemical cells. The graph includes cell thickness change in percentage for each group of the cells, where the cells were grouped by current output measured in milliamp hour. The x-axis percentage values are the ratio of actual cell capacity to the targeted nominal cell capacity of 178 mAh. FIG. 15 summarizes the swelling data of the twenty-four cells while the cells were discharged to 2.0 V and further to 0.0 V. The swelling at 2.0 Volts for the 100 percent milliampere hour group is about 1.5 percent, allowing a good margin for an implantable device design. As a comparison, electrochemical cells currently used in implantable designs typically exhibit swelling in the range of about 5 to 10%. Thus, the minimal swelling of about 1.5% from the cell allows the swelling of a connected implantable medical device to be below 5%, or below 10%. As observed in FIG. 15, there is a general trend that the swelling of cell after discharge to 0.0 Volts is lesser than that after discharge to 2.0 Volts, and some cells even shrank after discharge to 0.0V (see 90 percent milliamp hour group in FIG. 15). While not wanting to be bound by theory, it is understood that this may be attributed to the fact that the density of the discharge product i.e., carbon and LiF, is greater than the density of the reactants i.e., Li and CFx, and thus less volume is needed to hold the solids inside the container. Further, the internal pressure of the cell is less than the external air pressure, causing the shrinking of the cell, and hence a reduction in the cell thickness.

In an aspect, the electrochemical cells disclosed herein are useful in a variety of devices, such as implantable cardiac monitor (ICM) devices or other implantable medical products. In various aspects, the optimized selection of materials, i.e., the materials for cathode, electrolyte, separator, current collector, header, and cell case, and the optimized designs, i.e., the design of the cathode current collector, design of the anode current collector, anode to cathode ratio, electrolyte to cathode ratio, void volume ratio, etc., in the present disclosure may result in reduced gassing and minimal swelling during deep discharge of the electrochemical cell.

The following are some embodiments of the foregoing disclosure:

Embodiment 1: A header for an electrochemical cell, the header comprising:
a planar plate configured to cover an internal volume of the electrochemical cell; a side wall extending from an upper surface of the planar plate in a direction perpendicular to the upper surface; a recess defined by the upper surface of the planar plate and the side wall; and a first step and a second step on a lower surface of the planar plate, the first step and the second step configured to seal the internal volume.

Embodiment 2: The header of any previous embodiment, wherein the first step is directly on the lower surface of the planar plate and a length of the first step is less than a length of the planar plate.

Embodiment 3: The header of any previous embodiment, wherein the second step is directly on a lower surface of the first step, and a length of the second step is less than a length of the first step.

Embodiment 4: The header of any previous embodiment, wherein a width of the first step and a width of the second step are less than a width of the planar plate.

Embodiment 5: The header of any previous embodiment, wherein a width of the first step and a width of the second step are the same.

Embodiment 6: The header of any previous embodiment, wherein a width of the second step is less than a width of the first step.

Embodiment 7: The header of any previous embodiment, further comprising an opening in the planar plate, the opening configured as a vent, an opening configured to receive a ball seal, an opening configured to receive a tab portion of an anode current collector, an opening configured to receive a tab portion of a cathode current collector tab, or a combination thereof.

Embodiment 8: An electrochemical cell comprising: an anode; a cathode; a separator between the anode and the cathode; a cell casing housing the anode, the cathode and the separator; and the header of any previous embodiment, the header installed on the cell casing.

Embodiment 9: An electrochemical cell comprising: a cathode assembly comprising a cathode; an anode assembly comprising an anode; a header; an anode feedthrough pin extending through the header and protruding from a first lower surface of the header, wherein the anode feedthrough pin is electrically connected to the anode; and a cathode feedthrough pin extending through the header and protruding from a second lower surface of the header, wherein the cathode feedthrough pin is electrically connected to the cathode; wherein at least one of the cathode assembly and the anode assembly includes a separator pouch, the separator pouch enclosing at least one of: the cathode and an interior portion of the cathode feedthrough pin, and the anode and an interior portion of the anode feedthrough pin.

Embodiment 10: The electrochemical cell of any previous embodiment, wherein the separator pouch includes a cathode separator pouch and an anode separator pouch, the interior portion of the cathode feedthrough pin extends from the first lower surface of the header and is enclosed within the cathode assembly by the cathode separator pouch, and the interior portion of the anode feedthrough pin extends from the second lower surface of the header and is enclosed within the anode assembly by the anode separator pouch.

Embodiment 11: The electrochemical cell of any previous embodiment, wherein the anode comprises an anode composition disposed on a surface of an anode current collector and the anode is enclosed within the anode separator pouch, and the cathode comprises a cathode composition disposed on a surface of a cathode current collector and the cathode is enclosed within the cathode separator pouch.

Embodiment 12: The electrochemical cell of any previous embodiment, wherein the header comprises a planar plate, a side wall extending from an upper surface of the planar plate in a direction perpendicular to the upper surface of the planar plate, and a recess defined by the upper surface of the planar plate and the side wall.

Embodiment 13: The electrochemical cell of any previous embodiment, wherein a portion of the anode feedthrough pin and a portion of the cathode feedthrough pin each extends above an upper surface of the planar plate.

Embodiment 14: The electrochemical cell of any previous embodiment, wherein the header further comprises a first step on a lower surface of the planar plate and a second step on a lower surface of the first step.

Embodiment 15: The electrochemical cell of any previous embodiment, wherein a length of the first step is less than a length of the planar plate.

Embodiment 16: The electrochemical cell of any previous embodiment, wherein a length of the second step is less than a length of the first step.

Embodiment 17: The electrochemical cell of any previous embodiment, wherein a width of the first step and a width of the second step are the same, and wherein the width of the first step and the width of the second step are less than a width of the planar plate.

Embodiment 18: The electrochemical cell of any previous embodiment, wherein the anode feedthrough pin and the cathode feedthrough pin each extend through the planar plate, the first step, and the second step.

Embodiment 19: The electrochemical cell of any previous embodiment, wherein the portion of the cathode feedthrough pin protrudes from a lower surface of the second step, and the cathode separator pouch covers the portion of the cathode feedthrough pin extending from the lower surface of the second step.

Embodiment 20: The electrochemical cell of any previous embodiment, wherein the cathode assembly and the anode assembly are enclosed in an insulator pouch.

Embodiment 21: The electrochemical cell of any previous embodiment, wherein the electrochemical cell further comprises a cell casing and the insulator pouch is enclosed by the cell casing.

Embodiment 22: A header for an electrochemical cell, comprising: a header body including a planar plate having an upper surface, the upper surface defining a shape that corresponds to a shape of an electrochemical cell casing; and a peripheral band configured to extend along a periphery of the upper surface, the peripheral band configured to be sealed to the upper surface and the cell casing.

Embodiment 23: The header of any previous embodiment, wherein the planar plate is configured to be installed on the casing so that a recess is formed above the planar plate, the recess defined by the upper surface and a wall of the cell casing.

Embodiment 24: The header of any previous embodiment, wherein the peripheral band is configured to be sealed to the upper surface and a wall of the casing to create a double seal between an interior of the casing and an exterior of the cell casing.

Embodiment 25: The header of any previous embodiment, wherein the peripheral band is configured to be welded to the upper surface and the cell casing.

Embodiment 26: The header of any previous embodiment, further comprising a first passage configured to accommodate a cathode connection member, and a second passage configured to accommodate an anode connection member.

Embodiment 27: The header of any previous embodiment, wherein the first passage has a size selected to support a portion of the cathode connection member and a first sealing substrate within the first passage, and the second passage has a size selected to support a portion of the anode connection member and a second sealing substrate within the second passage.

Embodiment 28: The header of any previous embodiment, wherein the header is configured to be connected in a sealing arrangement to an implantable medical device.

Embodiment 29: An electrochemical cell comprising: an anode; a cathode; a separator between the anode and the cathode; a cell casing housing the anode, the cathode and the separator; and the header of any previous embodiment, the header installed on the cell casing.

Embodiment 30: A method of manufacturing an electrochemical cell, comprising: providing the header of any previous embodiment; and installing the header on a cell casing, the cell casing including an anode, a cathode, and a separator between the anode and the cathode.

Embodiment 31: The method of any previous embodiment, wherein the installing includes welding the header to the cell casing.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

“Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some aspect”, “an aspect”, and so forth, means that a particular element described in connection with the aspect is included in at least one aspect described herein, and may or may not be present in other aspects. In addition, it is to be understood that the described elements may be combined in any suitable manner in the various aspects. A “combination thereof” is open and includes any combination comprising at least one of the listed components or properties optionally together with a like or equivalent component or property not listed

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A header for an electrochemical cell, the header comprising:
a planar plate configured to cover an internal volume of the electrochemical cell;
a side wall extending from an upper surface of the planar plate in a direction perpendicular to the upper surface;
a recess defined by the upper surface of the planar plate and the side wall; and
a first step and a second step on a lower surface of the planar plate, the first step and the second step configured to seal the internal volume.

2. The header of claim 1, wherein the first step is directly on the lower surface of the planar plate and a length of the first step is less than a length of the planar plate.

3. The header of claim 2, wherein the second step is directly on a lower surface of the first step, and a length of the second step is less than a length of the first step.

4. The header of claim 1, wherein a width of the first step and a width of the second step are less than a width of the planar plate.

5. The header of claim 1, wherein a width of the first step and a width of the second step are the same or a width of the second step is less than a width of the first step.

6. (canceled)

7. The header of claim 1, further comprising an opening in the planar plate, the opening configured as a vent, an opening configured to receive a ball seal, an opening configured to receive a tab portion of an anode current collector, an opening configured to receive a tab portion of a cathode current collector tab, or a combination thereof.

8. An electrochemical cell comprising:
an anode;
a separator between the anode and cathode;
a cathode;
a cell casing housing the anode, the cathode, and the separator; and
the header of claim 1, the header installed on the cell casing.

9. An electrochemical cell comprising:
a cathode assembly comprising a cathode;
an anode assembly comprising an anode;
a header;
an anode feedthrough pin extending through the header and protruding from a first lower surface of the header, wherein the anode feedthrough pin is electrically connected to the anode; and
a cathode feedthrough pin extending through the header and protruding from a second lower surface of the header, wherein the cathode feedthrough pin is electrically connected to the cathode;
wherein at least one of the cathode assembly and the anode assembly includes a separator pouch, the separator pouch enclosing at least one of:
the cathode and an interior portion of the cathode feedthrough pin, and
the anode and an interior portion of the anode feedthrough pin.

10. The electrochemical cell of claim 9, wherein the separator pouch includes a cathode separator pouch and an anode separator pouch, the interior portion of the cathode feedthrough pin extends from the first lower surface of the header and is enclosed within the cathode assembly by the cathode separator pouch, and the interior portion of the anode feedthrough pin extends from the second lower surface of the header and is enclosed within the anode assembly by the anode separator pouch.

11. The electrochemical cell of claim 9, wherein the anode comprises an anode composition disposed on a surface of an anode current collector and the anode is enclosed within the anode separator pouch, and the cathode comprises a cathode composition disposed on a surface of a cathode current collector and the cathode is enclosed within the cathode separator pouch.

12. The electrochemical cell of claim 9, wherein the header comprises a planar plate, a side wall extending from an upper surface of the planar plate in a direction perpendicular to the upper surface of the planar plate, and a recess defined by the upper surface of the planar plate and the side wall.

13. The electrochemical cell of claim 12, wherein a portion of the anode feedthrough pin and a portion of the cathode feedthrough pin each extends above an upper surface of the planar plate.

14. The electrochemical cell of claim 12, wherein the header further comprises a first step on a lower surface of the planar plate and a second step on a lower surface of the first step.

15. (canceled)

16. (canceled)

17. (canceled)

18. The electrochemical cell of claim 14, wherein the anode feedthrough pin and the cathode feedthrough pin each extend through the planar plate, the first step, and the second step.

19. The electrochemical cell of claim 14, wherein the portion of the cathode feedthrough pin protrudes from a lower surface of the second step, and the cathode separator pouch covers the portion of the cathode feedthrough pin extending from the lower surface of the second step.

20. (canceled)

21. (canceled)

22. A header for an electrochemical cell, comprising:
a header body including a planar plate having an upper surface, the upper surface defining a shape that corresponds to a shape of an electrochemical cell casing; and
a peripheral band configured to extend along a periphery of the upper surface, the peripheral band configured to be sealed to the upper surface and the cell casing.

23. The header of claim 22, wherein the planar plate is configured to be installed on the casing so that a recess is formed above the planar plate, the recess defined by the upper surface and a wall of the casing.

24. The header of claim 22, wherein the peripheral band is configured to be sealed to the upper surface and a wall of the casing to create a double seal between an interior of the cell casing and an exterior of the cell casing.

25. (canceled)

26. The header of claim 22, further comprising a first passage configured to accommodate a cathode connection member, and a second passage configured to accommodate an anode connection member, and wherein the first passage has a size selected to support a portion of the cathode connection member and a first sealing substrate within the first passage, and the second passage has a size selected to support a portion of the anode connection member and a second sealing substrate within the second passage.

27. (canceled)

28. The header of claim 22, wherein the header is configured to be connected in a sealing arrangement to an implantable medical device.

29. An electrochemical cell comprising:
an anode;
a cathode;
a separator between the anode and cathode;
a cell casing housing the anode, the cathode, and the separator; and
the header of claim 22, the header installed on the cell casing.

30. A method of manufacturing an electrochemical cell, comprising:
providing the header of claim 1; and
installing the header on a cell casing, the cell casing including an anode, a cathode, and a separator between the anode and the cathode.

31. (canceled)
